(19) United States
(12) Patent Application Publication
(10) Pub. No.: US 2024/0241857 A1
(43) Pub. Date: Jul. 18, 2024

(54) ADAPTIVE PARAMETERIZATION OF PARALLELIZED FILE SYSTEM OPERATIONS

(71) Applicant: INTERNATIONAL BUSINESS MACHINES CORPORATION, Armonk, NY (US)

(72) Inventors: Qais NOORSHAMS, Frankfurt (DE); Shikhar KWATRA, San Jose, CA (US); Pradeep PARAMESHWARAN, Böblingen (DE); Sushain PANDIT, Austin, TX (US); Aaron K. BAUGHMAN, Cary, NC (US); Norman Christopher BÖWING, Boblingen (DE)

(21) Appl. No.: 18/155,786

(22) Filed: Jan. 18, 2023

(51) Int. Cl. G06F 16/16; G06F 16/18

(52) U.S. Cl. CPC G06F 16/16; G06F 16/1858

(57) ABSTRACT

Processing within a computing environment is facilitated by obtaining a parameterization for a parallelized file system operation of a file system of the computing environment, and executing, and determining performance of, the parallelized file system operation with the parameterization. The process further includes using machine learning to adjust one or more parameters of the parameterization based on performance of the parallelized file system operation to obtain a tuned parameterization, and executing the parallelized file system operation with the tuned parameterization, where the adjusting of one or more parameters of the parameterization enhances performance of the parallelized file system operation within the computing environment.

### BACKGROUND

One or more aspects relate, in general, to enhancing processing within a computing environment, and in particular to adaptive parameterization of parallelized file system operations for a clustered file system of the computing environment.

A clustered file system, or parallel file system, is a type of storage system capable of storing data across multiple network servers, and which provides concurrent access to a single file system or set of file systems from multiple nodes. The nodes can be storage-area network-attached or a mix of storage-area network and network-attached nodes. This enables high performance access to a common set of data to support, for instance, a scale-out solution or to provide a high availability platform. Clustered file systems can have features beyond common data access, including data replication, policy-based storage management, and multi-site operations. In one or more embodiments, clustered file systems can run on virtualized instances providing common data access in environments, and leverage logical partitioning, or other hypervisors.

### SUMMARY

Certain shortcomings of the prior art are overcome, and additional advantages are provided herein through the provision of a computer-implemented method of facilitating processing within a computing environment. The computer-implemented method includes: obtaining a parameterization for a parallelized file system operation of a file system of the computing environment, and executing, and determining performance of, the parallelized file system operation with the parameterization. Further, the computer-implemented method includes using machine learning to adjust one or more parameters of the parameterization based on performance of the parallelized file system operation to obtain a tuned parameterization, and executing the parallelized file system operation with the tuned parameterization, where the adjusting one or more parameters of the parameterization enhances performance of the parallelized file system operation within the computing environment.

Computer systems and computer program products relating to one or more aspects are also described and claimed herein. Further, services relating to one or more aspects are also described and may be claimed herein.

Additional features and advantages are realized through the techniques described herein. Other embodiments and aspects are described in detail herein and are considered a part of the claimed aspects.

### BRIEF DESCRIPTION OF THE DRAWINGS

One or more aspects are particularly pointed out and distinctly claimed as examples in the claims at the conclusion of the specification. The foregoing and objects, features, and advantages of one or more aspects are apparent from the following detailed description taken in conjunction with the accompanying drawings in which:

FIG. 1 depicts one example of a computing environment to include and/or use one or more aspects of the present invention;

FIG. 2 depicts one embodiment of a computer program product with an adaptive file system operation parameterization module, in accordance with one or more aspects of the present invention;

FIG. 3 depicts one embodiment of an adaptive file system operation parameterization process, in accordance with one or more aspects of the present invention;

FIG. 4 is a further example of a computing environment to include and/or use one or more aspects of the present invention;

FIG. 5A depicts one example of a hierarchical directory structure on which a parallelized file system operation can be performed, in accordance with one or more aspects of the present invention;

FIG. 5B depicts the hierarchical directory structure of FIG. 5A, with one example of a dynamic thread starting process illustrated, in accordance with one or more aspects of the present invention;

FIG. 5C depicts the hierarchical directory structure of FIGS. 5A-5B, with an average width parameter and an average depth parameter for an adaptive parameterization process illustrated, in accordance with one or more aspects of the present invention;

FIG. 6 depicts another example of an adaptive file system operation parameterization process, in accordance with one or more aspects of the present invention;

FIG. 7 depicts a further embodiment of adaptive file system operation processing, in accordance with one or more aspects of the present invention; and

FIG. 8 depicts a further embodiment of an adaptive file system operation parameterization process, in accordance with one or more aspects of the present invention.

### DETAILED DESCRIPTION

The accompanying figures, which are incorporated in and form a part of this specification, further illustrate the present invention and, together with this detailed description of the invention, serve to explain aspects of the present invention. Note in this regard that descriptions of well-known systems, devices, processing techniques, etc., are omitted so as to not unnecessarily obscure the invention in detail. It should be understood, however, that the detailed description and this specific example(s), while indicating aspects of the invention, are given by way of illustration only, and not limitation. Various substitutions, modifications, additions, and/or other arrangements, within the spirit or scope of the underlying inventive concepts will be apparent to those skilled in the art from this disclosure. Note further that numerous inventive aspects or features are disclosed herein, and unless inconsistent, each disclosed aspect or feature is combinable with any other disclosed aspect or feature as desired for a particular application of the concepts disclosed.

Note also that illustrative embodiments are described below using specific code, designs, architectures, protocols, layouts, schematics, or tools only as examples, and not by way of limitation. Furthermore, the illustrative embodiments are described in certain instances using particular software, hardware, tools, or data processing environments only as example for clarity of description. The illustrative embodiments can be used in conjunction with other comparable or similarly purposed structures, systems, applications, or architectures. One or more aspects of an illustrative embodiment can be implemented in software, hardware, or a combination thereof.

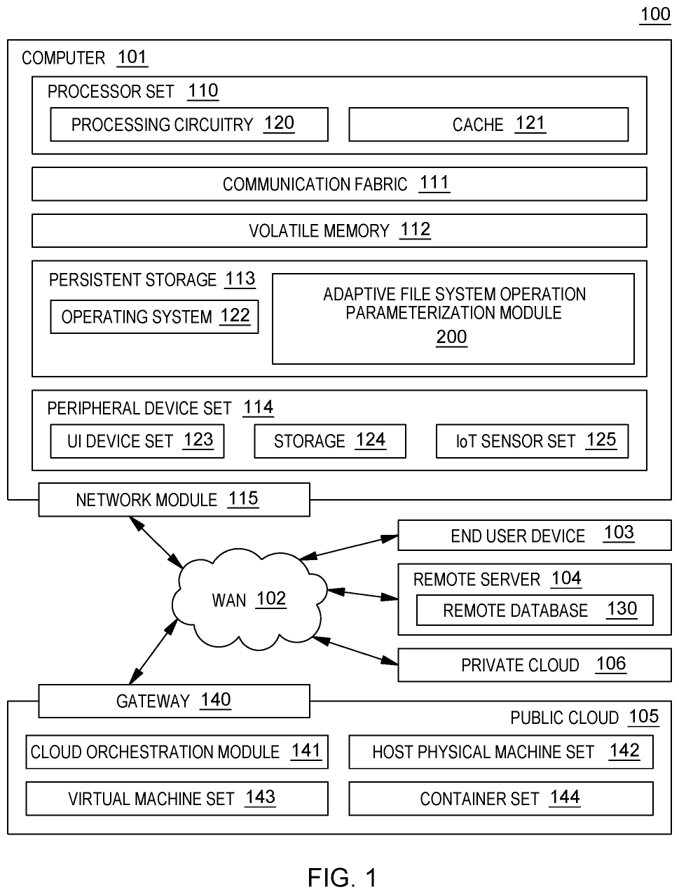

As understood by one skilled in the art, program code, as referred to in this application, can include software and/or hardware. For example, program code in certain embodiments of the present invention can utilize a software-based implementation of the functions described, while other embodiments can include fixed function hardware. Certain embodiments combine both types of program code. Examples of program code, also referred to as one or more programs, are depicted in FIG. 1, including operating system 122 and adaptive file system operation parameterization module 200, which are stored in persistent storage 113.

One or more aspects of the present invention are incorporated in, performed and/or used by a computing environment. As examples, the computing environment can be of various architectures and of various types, including, but not limited to: personal computing, client-server, distributed, virtual, emulated, partitioned, non-partitioned, cloud-based, quantum, grid, time-sharing, clustered, peer-to-peer, mobile, having one node or multiple nodes, having one processor or multiple processors, and/or any other type of environment and/or configuration, etc., that is capable of executing a process (or multiple processes) that, e.g., perform automated container name identification processing, such as disclosed herein. Aspects of the present invention are not limited to a particular architecture or environment.

Prior to further describing detailed embodiments of the present invention, an example of a computing environment to include and/or use one or more aspects of the present invention is discussed below with reference to FIG. 1.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as adaptive file system operation parameterization module block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface type operating systems that employ a kernel. The code included in block 126 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The computing environment described above is only one example of a computing environment to incorporate, perform and/or use one or more aspects of the present invention. Other examples are possible. Further, in one or more embodiments, one or more of the components/modules of FIG. 1 need not be included in the computing environment and/or are not used for one or more aspects of the present invention. Further, in one or more embodiments, additional and/or other components/modules can be used. Other variations are possible.

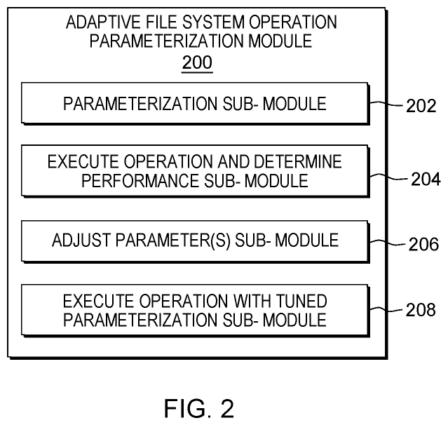

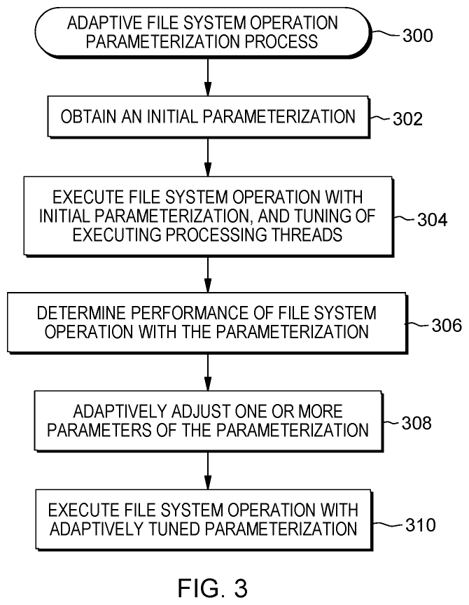

By way of example, one or more embodiments of an adaptive file system operation parameterization module and process are described initially with reference to FIGS. 2-3. FIG. 2 depicts one embodiment of adaptive file system operation parameterization module 200 that includes code or instructions to perform adaptive parameterization processing, in accordance with one or more aspects of the present invention, and FIG. 3 depicts one embodiment of an adaptive file system operation parameterization process, in accordance with one or more aspects of the present invention.

Referring to FIGS. 1 & 2, adaptive file system operation parameterization module 200 includes, in one example, various sub-modules used to perform self-tuning parameterization processing, in accordance with one or more aspects of the present invention. The sub-modules are, e.g., computer-readable program code (e.g., instructions) and computer-readable media (e.g., persistent storage (e.g., persistent storage 113, such as a disk) and/or a cache (e.g., cache 121), as examples). The computer-readable media can be part of a computer program product and can be executed by and/or using one or more computers, such as computer(s) 101; processors, such as a processor of processor set 110; and/or processing circuitry, such as processing circuitry of processor set 110, etc.

In the FIG. 2 embodiment, example sub-modules of adaptive file system operation parameterization module 200 include, for instance, a parameterization sub-module 202 to obtain a parameterization for a parallelized file system operation of a file system of the computing environment; an execute operation and determine performance sub-module 204 to execute the parallelized file system operation with the initial parameterization, and to facilitate tuning of executing processing threads; an adjust parameter(s) sub-module 206 to use obtained data on performance of the file system operation with the parameterization, to adaptively adjust, via machine learning, one or more parameters of the parameterization based on the performance data to obtain a tuned parameterization; and an execute operation with tuned parameterization sub-module 208 to execute the file system operation using the adaptively tuned parameterization. Advantageously, using machine learning to adjust one or more parameters of the parameterization enhances performance of the parallelized file system operation within the computing environment, and thus facilitates processing within the computing environment. Note that although various sub-modules are described, adaptive file system operation parameterization module processing such as disclosed herein can use, or include, additional, fewer, and/or different sub-modules. A particular sub-module can include additional code, including code of other sub-modules, or less code. Further, additional and/or other modules can be used. Many variations are possible.

In one or more embodiments, the sub-modules are used, in accordance with one or more aspects of the present invention, to perform adaptive parameterization processing. FIG. 3 depicts one example of an automated adaptive parameterization process, such as disclosed herein. The process is executed, in one or more examples, by a computer (e.g., computer 101 (FIG. 1)), and/or a processor or processing circuitry (e.g., of processor set 110 of FIG. 1). In one example, code or instructions implementing the process, are part of a module, such as adaptive file system operation parameterization module 200. In other examples, the code can be included in one or more other modules and/or in one or more sub-modules of the one or more other modules. Various options are available.

As one example, adaptive file system operation parameterization process 300 executing on a computer (e.g., computer 101 of FIG. 1), a processor (e.g., a processor of processor set 110 of FIG. 1), and/or processing circuitry (e.g., processing circuitry of processor set 110), obtains an initial parameterization 302 for a parallelized file system operation of a file system of the computing environment, such as for a clustered file system of the computing environment. In one embodiment, the initial parameterization can be based, at least in part, on expected average directory breadth and depth. Adaptive file system operation parameterization process 300 further includes executing the parallelized file system operation with initial parameterization, and tuning the number of executing processing threads 304. In addition, the adaptive parameterization processing includes determining performance of the parallelized file system operation with the parameterization 306, for instance, by collecting performance metrics or other information or data associated with executing the parallelized file system operation using the initial parameterization.

As illustrated, adaptive file system operation parameterization processing 300 further includes adaptively adjusting one or more parameters of the parameterization 308, for instance, based on performance of the parallelized file system operation, to provide a tuned parameterization of the parallelized file system operation. In one embodiment, one or more machine learning models are used to facilitate adaptive adjusting of one or more parameters of the parameterization. For instance, in one embodiment, the adaptive parameterization process can collect performance data, including, for example, execution time of the file system operation, as well as values used for different parameters of the parameterization, and store the information in a knowledge base or common data store. One or more parameters of the parameterization can then be changed or tuned heuristically based on the file system structure, such as explained herein.

Further, in one or more embodiments, adaptive parameterization process 300 also includes executing the file system operation with the adaptively tuned parameterization 310, where the adjusting one or more parameters of the parameterization enhances performance of the parallelized file system operation within the computing environment.

Advantageously, a novel approach is provided herein to monitoring and adaptively self-tuning one or more performance parameters for, for instance, parallelized big data file system operations to optimize the operations for execution. For instance, in one embodiment, the process can advantageously be used with an open source distributed file system protocol which handles large data sets to be used in a clustered file system environment, where, for instance, remote procedure calls (RPCs) are translated into clustered or parallelized file system operations. In such an environment, executing the distributed file system call operations can take significantly longer compared to, for instance, directly executing a corresponding operation of the clustered file system. The performance improvements sought depend on the particular system environment and parameters used to adapt an algorithm from one environment to the other. Finding and setting optimum parameters can be complex and different for each environment. Disclosed herein are certain novel processes for adaptively tuning parameterization for a parallelized file system operation to enhance performance of the operation within one or more environments.

In one or more implementations, the adaptive file system operation parameterization processing disclosed herein facilitates operation of a distributed file system protocol on a clustered file system environment using, for instance, remote procedure calls translated to respective operations of the clustered file system. In particular, a novel approach to monitoring and adaptively self-tuning performance parameters for parallelized big data file system operations is provided to optimize the operations when translated for accessing, for instance, a clustered file system environment. After bootstrapping and/or seeding per heuristic selection of parameters, in certain embodiments, the system or process also trains one or more neural networks to learn a model for mapping system metrics to tunable parameters which govern one or more desired, or specified, operational characteristics to be enhanced, such as operation processing time, etc.

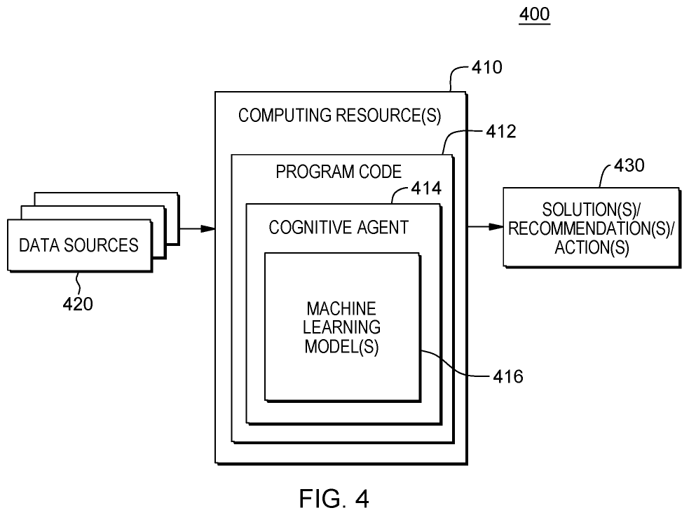

By way of further explanation, FIG. 4 depicts another embodiment of a computing environment or system 400, which can incorporate, or implement, one or more aspects of an embodiment of the present invention. In one or more implementations, system 400 is implemented as part of a computing environment, such as computing environment 100 described above in connection with FIG. 1. System 400 includes one or more computing resources 410 that execute program code 412 that implements, for instance, one or more aspects of a module or facility such as disclosed herein, and which includes a cognitive engine or agent 414, which utilizes one or more machine learning models 416, such as described herein. Data, such as file system structure data, performance metrics data or other data associated with execution of a file system operation, is used by cognitive agent 414, to train model(s) 416 to (for instance) determine one or more parameter change values for adjusting one or more parameters of a parameterization used in executing parallelized file system operations, and/or other related actions 430, etc., based on the particular application of the machine-learning model(s) to facilitate achieving the adaptive parameterization workflow disclosed. In implementation, system 400 can include, or utilize, one or more networks for interfacing various aspects of computing resource(s) 410, as well as one or more data sources 420 providing data, and one or more components, systems, etc., receiving an output, action, etc., 430 of machine learning model(s) 416 to facilitate performance of one or more parallelized file system operations. By way of example, the network(s) can be, for instance, a telecommunications network, a local-area network (LAN), a wide-area network (WAN), such as the Internet, or a combination thereof, and can include wired, wireless, fiber-optic connections, etc. The network(s) can include one or more wired and/or wireless networks that are capable of receiving and transmitting data, including training data for the machine-learning model, and an output solution, recommendation, action, of the machine-learning model, such as discussed herein.

In one or more implementations, computing resource(s) 410 house and/or execute program code 412 configured to perform methods in accordance with one or more aspects of the present invention. By way of example, computing resource(s) 410 can be a computing-system-implemented resource(s). Further, for illustrative purposes only, computing resource(s) 410 in FIG. 4 is depicted as being a single computing resource. This is a non-limiting example of an implementation. In one or more other implementations, computing resource(s) 410, by which one or more aspects of incident detect processing, such as discussed herein can, at least in part, be implemented in multiple separate computing resources or systems, such as one or more computing resources of a cloud-hosting environment, by way of example.

Briefly described, in one embodiment, computing resource(s) 410 can include one or more processors, for instance, central processing units (CPUs). Also, the processor(s) can include functional components used in the integration of program code, such as functional components to fetch program code from locations in such as cache or main memory, decode program code, and execute program code, access memory for instruction execution, and write results of the executed instructions or code. The processor(s) can also include a register(s) to be used by one or more of the functional components. In one or more embodiments, the computing resource(s) can include memory, input/output, a network interface, and storage, which can include and/or access, one or more other computing resources and/or databases, as required to implement the machine-learning processing described herein. The components of the respective computing resource(s) can be coupled to each other via one or more buses and/or other connections. Bus connections can be one or more of any of several types of bus structures, including a memory bus or a memory controller, a peripheral bus, an accelerated graphics port, and a processor or local bus, using any of a variety of architectures. By way of example, but not limitation, such architectures can include the Industry Standard Architecture (ISA), the micro-channel architecture (MCA), the enhanced ISA (EISA), the Video Electronic Standard Association (VESA), local bus, and peripheral component interconnect (PCI). As noted, examples of a computing resource(s) or a computer system(s) which can implement one or more aspects disclosed are described further herein with reference to the figures.

In one embodiment, program code 412 executes a cognitive engine or agent 414 which includes and trains one or more models 416. The models can be trained using training data that can include a variety of types of data, depending on the model and the data sources. In one or more embodiments, program code 412 executing on one or more computing resources 410 applies one or more algorithms of cognitive agent 414 to generate and train the model(s), which the program code then utilizes to determine a change value for self-tuning or adaptively adjusting parameterization of a parallelized file system operation of a file system of the computing environment, and depending on the application, to perform an action (e.g., apply an ascertained parameter delta to a parameter of the parameterization for use in executing the parallelized file system operation, etc.). In an initialization or learning stage, program code 412 trains one or more machine learning models 416 using obtained training data that can include, in one or more embodiments, one or more parameters, files system structure data, performance metrics data, etc., such as described herein.

Data used to train the models (in one or more embodiments of the present invention) can include a variety of types of data, such as heterogeneous data generated by one or more data sources and/or data stored in one or more logs, or accessible by, the computing resource(s). Program code, in embodiments of the present invention, can perform data analysis to generate data structures, including algorithms utilized by the program code to predict and/or perform an action. As known, machine-learning-based modeling solves problems that cannot be solved by numerical means alone. In one example, program code extracts features/attributes from training data, which can be stored in memory or one or more databases. The extracted features can be utilized to develop a predictor function, h(x), also referred to as a hypothesis, which the program code utilizes as a model. In identifying machine learning model(s) 416, various techniques can be used to select features (elements, patterns, attributes, etc.), including but not limited to, diffusion mapping, principal component analysis, recursive feature elimination (a brute force approach to selecting features), and/or a random forest, to select the attributes related to the particular model. Program code can utilize one or more algorithms to train the model(s) (e.g., the algorithms utilized by program code), including providing weights for conclusions, so that the program code can train any predictor or performance functions included in the model. The conclusions can be evaluated by a quality metric. By selecting a diverse set of training data, the program code trains the model to identify and weight various attributes (e.g., features, patterns) that correlate to enhanced performance of the model.

In one or more embodiments, program code, executing on one or more processors, utilizes an existing cognitive analysis tool or agent (now known or later developed) to tune the model, based on data obtained from one or more data sources. In one or more embodiments, the program code can interface with application programming interfaces to perform a cognitive analysis of obtained data. Specifically, in one or more embodiments, certain application programing interfaces include a cognitive agent (e.g., learning agent) that includes one or more programs, including, but not limited to, natural language classifiers, a retrieve-and-rank service that can surface the most relevant information from a collection of documents, concepts/visual insights, tradeoff analytics, document conversion, and/or relationship extraction. In an embodiment, one or more programs analyze the data obtained by the program code across various sources utilizing one or more of a natural language classifier, retrieve-and-rank application programming interfaces, and tradeoff analytics application programing interfaces.

In one or more embodiments of the present invention, the program code can utilize one or more neural networks to analyze training data and/or collected data to generate an operational machine-learning model. Neural networks are a programming paradigm which enable a computer to learn from observational data. This learning is referred to as deep learning, which is a set of techniques for learning in neural networks. Neural networks, including modular neural networks, are capable of pattern (e.g., state) recognition with speed, accuracy, and efficiency, in situations where datasets are mutual and expansive, including across a distributed network, including but not limited to, cloud computing systems. Modern neural networks are non-linear statistical data modeling tools. They are usually used to model complex relationships between inputs and outputs, or to identify patterns (e.g., states) in data (i.e., neural networks are non-linear statistical data modeling or decision-making tools). In general, program code utilizing neural networks can model complex relationships between inputs and outputs and identified patterns in data. Because of the speed and efficiency of neural networks, especially when parsing multiple complex datasets, neural networks and deep learning provide solutions to many problems in multi-source processing, which program code, in embodiments of the present invention, can utilize in implementing a machine-learning model, such as described herein.

Advantageously, disclosed herein are intelligent and automatic processes to monitor and adaptively self-tune parameterization for parallelized big data file system operations to optimize the operations for, for instance, a clustered file system environment. After bootstrapping or seeding per heuristic selection of parameters, in certain embodiments, the process trains and uses one or more neural network models for mapping, for instance, system metrics to tunable parameters which govern operational characteristics of interest, such as operation processing time, for a particular clustered file system structure and the parallelized file system operation.

By way of example, embodiments of the present invention include computer-implemented methods, computer systems and computer program products, where program code executing on one or more processors facilitates processing within the computing environment by obtaining a parameterization for a parallelized file system operation of a file system of the computing environment, and executing, and determining performance of, the parallelized file system operation with the parameterization. The process further includes using machine learning to adjust one or more parameters of the parameterization based on performance of the parallelized file system operation to obtain a tuned parameterization, and executing the parallelized file system operation with the tuned parameterization, where the adjusting of one or more parameters of the parameterization enhances performance of the parallelized file system operation of the computing environment.

In one or more embodiments, using machine learning to adjust the one or more parameters of the parameterization includes changing the one or more parameters heuristically based on the structure of the file system. In one embodiment, the parameterization includes an initial parameterization based on one or more expected average parameter values.

In one or more further embodiments, determining performance of the parallelized file system operation with the parameterization includes collecting data associated with the executing of the parallelized file system operation with the parameterization, and storing the collected data. For instance, in one embodiment, using machine learning to adjust one or more parameters of the parameterization includes determining a parameter delta for a parameter of the one or more parameters of the parameterization, and based on the parameter delta exceeding a parameter delta threshold, adjusting the parameter of the one or more parameters of the parameterization to, at least in part, obtain the tuned parameterization. In one embodiment, using machine learning to adjust one or more parameters includes using a machine learning model for mapping the collected data to the one or more parameters of the parameterization, with the one or more parameters effecting a desired operational characteristic for executing the parallelized file system operation.

In one or more implementations, the file system is a clustered file system, and executing the parallelized file system operation with the parameterization includes obtaining multiple partitions of directories of the file system, and distributing partitions of the multiple partitions of directories of the file system among available processing threads of the computing environment, and storing undistributed partitions in a common storage. In one or more embodiments, the executing further includes determining whether an average execution time of the parallelized file system operation exceeds an average execution time threshold, and based on the average execution time of the parallelized file system operation exceeding the average execution time threshold, spawning one or more new processing threads to facilitate execution of the parallelized file system operation with the parameterization for any remaining undistributed partitions in the common storage.

In one or more embodiments, the parameterization includes multiple parameters. For instance, the multiple parameters include, in one embodiment, a maximum number of processing threads for use in executing the parallelized file system operation, a horizontal limit of directories for the multiple partitions of directories of the file system, and a vertical limit of sub-directories for the multiple partitions of directories of the file system.

In one specific example, disclosed herein are computer-implemented methods, computer systems and computer program products, where program code executing on one or more processors facilitates monitoring and adaptively self-tuning performance parameters for parallelized big data file system operations to, for instance, optimize distributed file system operations translated for accessing parallel or clustered file systems. The processing includes, in one or more embodiments, receiving an initial parameterization, and collecting information on parallel processing of the operation based on expected average directory breadth and depth. Further, the process includes, in one embodiment, distributing partitions of directories to be evaluated among available threads, and storing any remaining partitions in a common data store. In one embodiment, the process can further include determining that the average processing time of threads exceeds a set threshold and that unassigned partitions still to be processed, and based thereon, spawning one or more new threads to process one or more of the remaining, undistributed partitions in the common data store. Further, in one embodiment, the process includes collecting, along with thread processing time, performance information and storing the performance information in a knowledge database. The stored information is then used, in one embodiment, by machine learning in determining parameter delta(s) for one or more parameters of the parameterization to be used in adaptively changing one or more parameter values for a next processing of the file system operation.

Advantageously, in one or more embodiments, disclosed herein are adaptive file system operation parameterization processes, which are, for instance, stochastic based on inverse proportional sampling with file handling. In one embodiment, processes are disclosed where bootstrapped neural networks learn a mapping of system functions for operations for files on a clustered file system. In another embodiment, file-based parameters are optimized using machine learning for, for instance, enhancing execution time of the file system operation(s) using the optimized parameters. For instance, in one aspect, file depth based and nested operation optimizations can be used, based on machine learning models, for selected file based parameters associated with the particular file system operation.

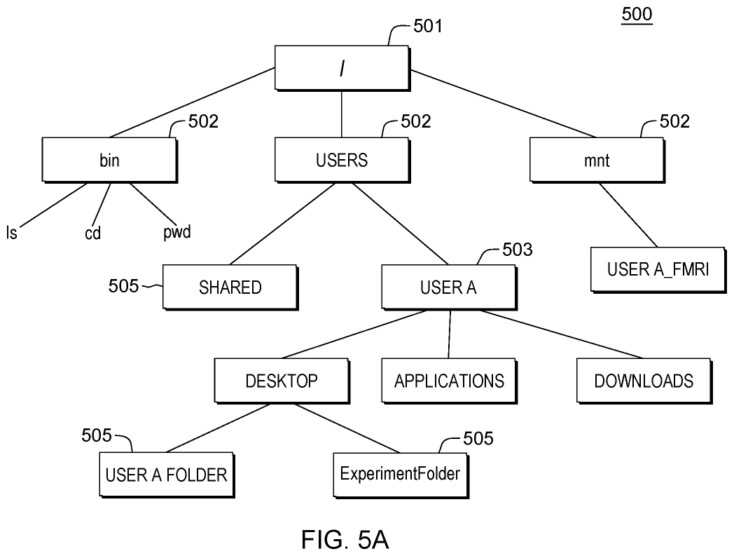

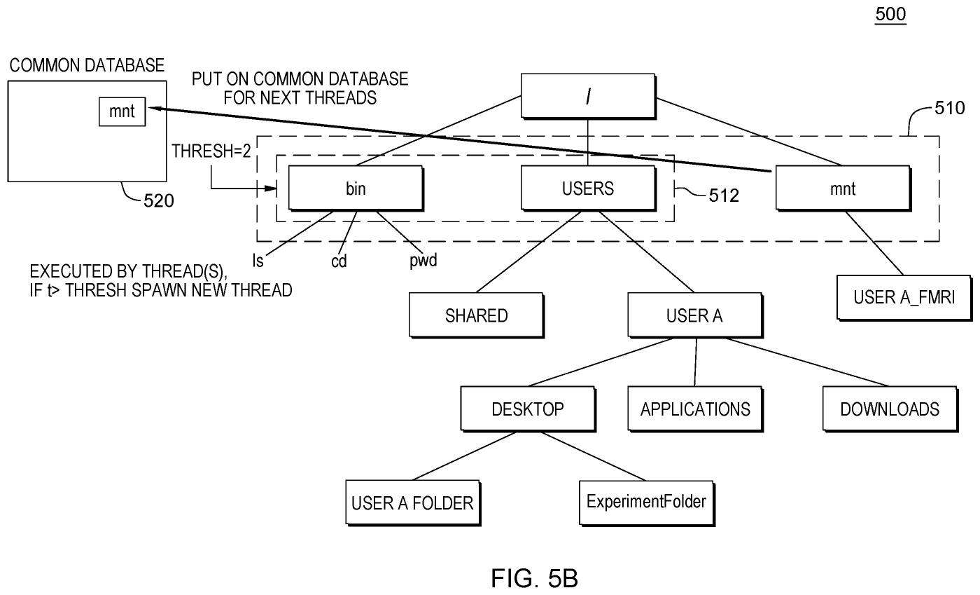

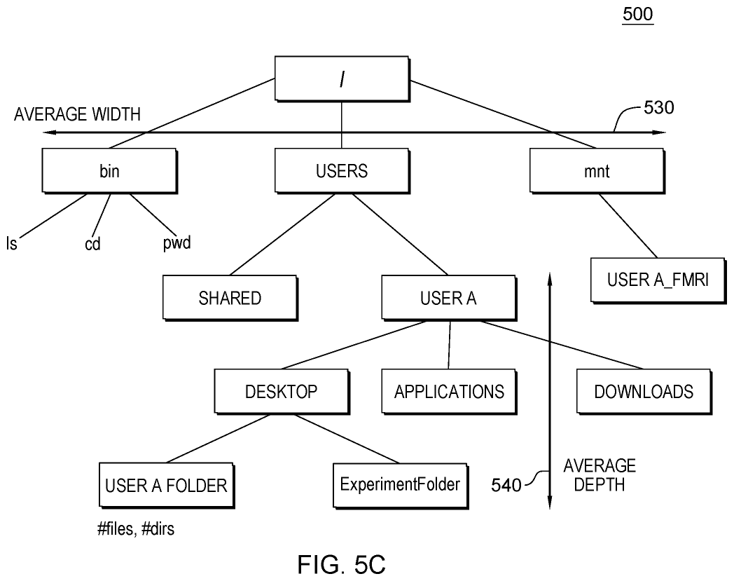

As an example only, FIG. 5A depicts one embodiment of a hierarchical file system directory structure 500 on which a parallelized file system operation can be performed. Those skilled in the art will note that hierarchical directory structure 500 is a simplified version of a file directory structure, which can be vastly larger and more complex. In the example structure of FIG. 5A, a root directory 501 has multiple sub-directories 502, which themselves can have files 505 or further sub-directories 503 associated therewith. For this hierarchical directory structure example, the file system can have one or more associated file system operations or functions, which allow, for instance, a user to navigate through the directories to gather statistics, such as usage statistics. In one example, disk usage statistics can be gathered via a disk usage operation of a native distributed file system protocol, with the relevant operation typically navigating through directories recursively in a single thread.

In a multithreading or parallelized file system operation implementation of the protocol, a variety of operation parameters can be set for use in executing the parallelized operation. For instance, for a multithreading disk utilization operation, the parameterizations can include three new parameters, including: parallel.summary.max-thread-count (default 512): max parallelism; parallel.summary.per-dir-threshold (default 10000): horizontal limit (or threshold) of directories; and parallel.summary.sub-dir-threshold (default 1000): vertical sub-directory limit (or threshold). Disclosed herein are processes for dynamically adaptively adjusting one or more of the parameterization values to facilitate optimizing a desired or specified aspect of the parallelized file system operation performance.

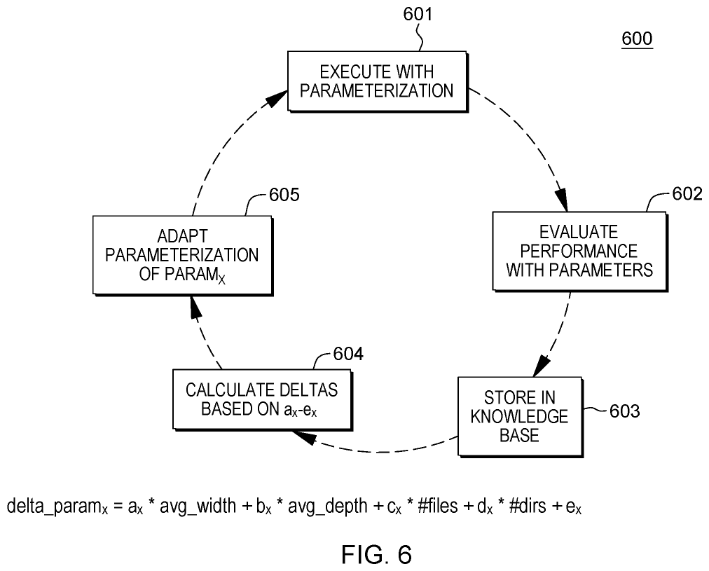

As disclosed, provided herein are computer-implemented methods, computer systems and computer program products implementing a novel process for monitoring and adaptively self-tuning performance parameters for parallelized big data file system operations to, for instance, optimize distributed file system operations or protocols when translated for use in accessing parallel or clustered file systems. One or more translators are commercially available to facilitate this process. A translator generally facilitates translation by adding, removing, and/or replacing one or more native system operation calls for each distributed file system operation to use with the clustered file system. In one or more implementations, single read and/or write requests can lead to multiple individual calls to the respective components of the protocol, and each of these components can issue the required native calls for the underlying, persistent clustered file system. FIG. 6 is an overview of one embodiment of process 600, which includes, for instance, executing a parallelized file system operation of a file system with parameterization 601. In one embodiment, this can include obtaining an initial parameterization for the operation, executing the parallelized file system operation using the initial parameterization and collecting performance data, where the initial parameterization can be based on, for instance, expected average directory breadth and expected average depth of the hierarchical file tree structure.

As illustrated in FIG. 6, performance of the operation is evaluated when using the existing parameters 602, and performance data is stored in a knowledge base 603. As part of the parallelized file system operation processing, partitions of the directories are obtained and distributed among available processing threads, with the any remaining partitions being stored in a common database or data store, as illustrated in FIG. 5B.

In the example of FIG. 5B, it is assumed by way of example that initially two processing threads are available for processing directories 510, such as for processing the bin and USERS directories 512 of hierarchical data structure 500. As part of the processing, average processing time of the threads is determined, and if the average processing time of the two threads exceeds a set threshold, and partitions or threads are available (e.g., there is currently less than the max specified parallelization), then one or more new threads can be spawned to process the remaining undistributed directories (e.g., mnt) stored in knowledge base 520.

As illustrated in FIG. 6, in one embodiment, adaptive parameterization such as disclosed herein uses information stored in knowledge base 603 to change, for instance, one or more parameters heuristically based on file system structure. For instance, in the example described, three parameters are used, labeled param 1, param 2 and param 3, which can in one embodiment, reference the max parallelism, horizontal directory limit and vertical sub-directory limit noted above. Examples of the horizontal directory average width 530 and the vertical sub-directory average depth 540 are illustrated in FIG. 5C for the hierarchical file structure 500 of FIGS. 5A-5B. For the example illustrated, delta_paramₓ can be defined (in one embodiment) as:

$${delta\_param}_{x} = {a}_{x} \times avg\_width + {b}_{x} \times avg\_depth + {c}_{x} \times \#files + {d}_{x} \times \# dirs + {e}_{x}$$

In this example, the delta_paramₓ being calculated on the basis of aₓ-eₓ is indicative of how much the particular parameter should change, if at all, in order to further optimize the desired operational characteristic when executing the parallelized file system operation using the parameters defined. In one or more implementations, delta_param thresholds can be specified for the parameters used by a parallelized file system operation. Where delta_param exceeds its specified delta_param threshold, then the respective parameter can be changed by the delta_param amount. In one or more implementations, this process can repeat for each parameter of the parameterization used by the parallelized file system operation.

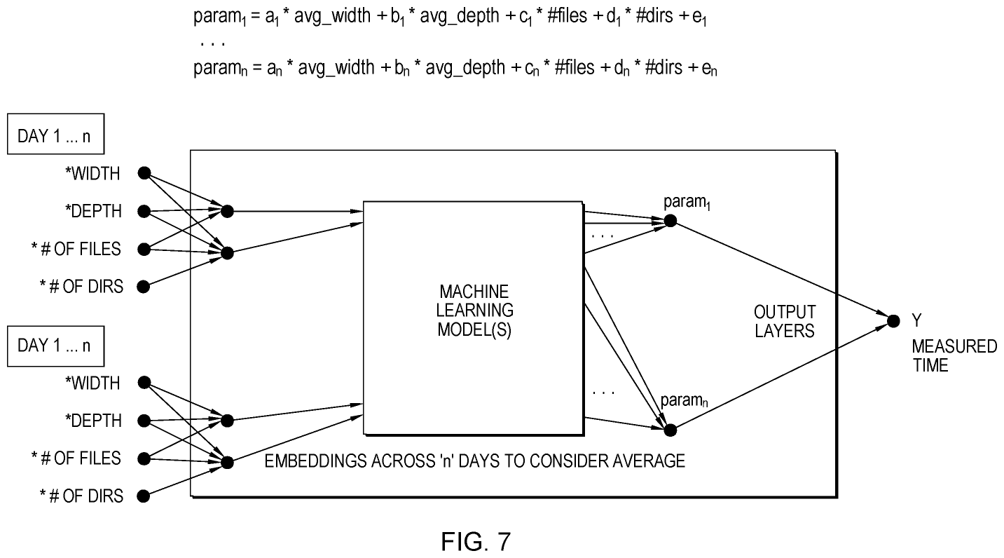

As part of the adaptive parameterization process, after bootstrapping/seeding per-heuristic selection of parameters, the adaptive parameterization process includes, in one or more embodiments, training one or more coupled neural networks to learn a model for mapping system metrics to tunable parameters which govern one or more desired operational characteristics of the file system operation process (e.g., processing time). An example of this is depicted in FIG. 7, were param₁ . . . paramₙ are being determined by multiple neural networks to learn a model mapping of, for instance, the width of directories, the depth of sub-directories, the number of files, the number of directories, etc., to specific parameters (param₁ . . . paramₙ) of the parameterization using the noted equations, where αₓ . . . eₓ are learned across n days to consider an average of the values over a period of time. In addition to determining the delta parameters, the measured time y can also be determined, as illustrated in FIG. 7.

In one or more embodiments, adaptive parameterization stochastic sampling is used with a plurality of machine learning models. For instance, a plurality of machine learning models can be created for adaptive parameterization over time. For a duration of time, all of the models are maintained. In one embodiment, the algorithm can randomly sample a model over a time window. The sampling number is, in one embodiment, equal and inversely proportional to the performance of the system (1/m)×100, where m is the return time. In one embodiment, the machine learning is implemented as a set of layered neural networks.

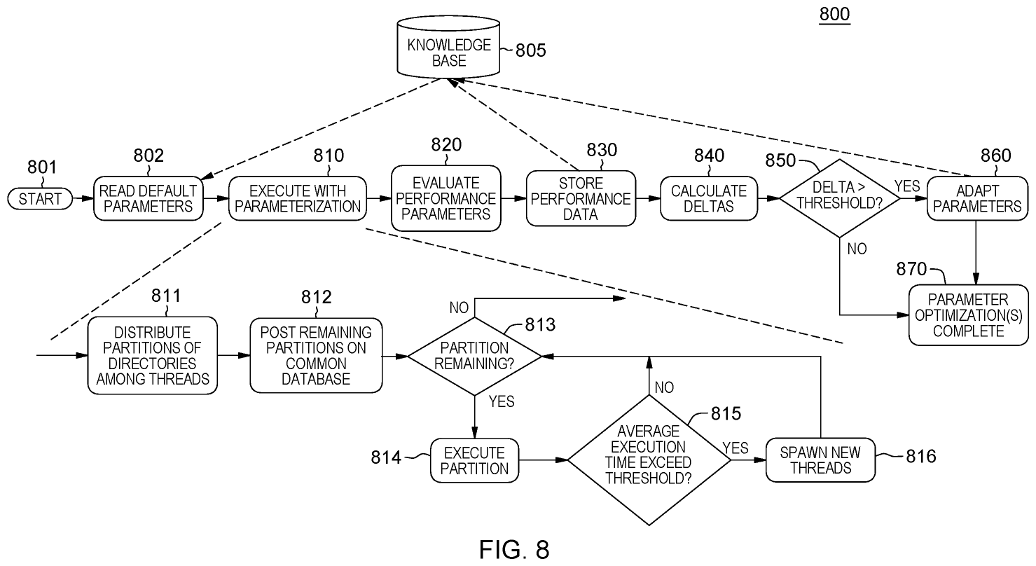

By way of example, FIG. 8 depicts a further embodiment of an adaptive file system operation parameterization process 800, in accordance with one or more aspects of the present invention. In one embodiment, the figure represents a computer-implemented method of monitoring and adaptively self-tuning performance parameters for parallelized bit data file system operations to, for instance, optimize a distributed file system operation or protocol translated for accessing a parallel or clustered file system(s).

As illustrated, the adaptive parameterization process 800 starts 801 with reading default parameters of the parameterization 802. In one embodiment, the default parameters can be obtained from a knowledge base or datastore 805. The adaptive parameterization process 800 includes executing the parallelized file system operation with the initial, default parameterization 810. This can include, in one or more embodiments, distributing partitions of directories among available processing threads 811, and posting any remaining partitions or undistributed partitions to a common database 812. Processing determines whether any partitions remain 813, and if so, executes a next partition 814. Further, processing determines whether the average operation execution time for the partitions exceeds a set threshold 815, and if “yes”, one or more new processing threads are spawned 816 to facilitate processing one or more remaining partitions 813 pending on the common database. Once the operation has been executed for all partitions, processing evaluates the performance parameters 820. The performance data is stored 830 in a common datastore, such as knowledge base 805. The performance data is then used by machine learning to calculate one or more delta parameters 840 (delta_paramₓ), such as described herein. Processing determines whether a particular delta parameter exceeds a corresponding threshold 850, and if “yes”, adapts the one or more parameters 860 using, for instance, the determined delta_param of the parameter. Once the parameter(s) have been adapted, or the delta params have been determined not to exceed the corresponding thresholds, parameter optimization is complete 870. In one or more implementations, the process can be repeated a plurality of times as desired in order to optimize parameters for a particular implementation.

Advantageously, disclosed herein are automated performance tuning processes, which do not require manual analysis or any specialized knowledge. Further, the adaptive parameterization processes are adaptive to a changing environment, for example, if the system is growing over time, or a typical usage pattern is changing. Further, the adaptive parameterization processing disclosed herein is applicable for a number of different parallelized file system operations, such as, for instance, disk usage, parallel deletion, etc.

Other aspects, variations and/or embodiments are possible.

The computing environments described herein are only examples of computing environments that can be used. Other environments may be used; embodiments are not limited to any one environment. Although various examples of computing environments are described herein, one or more aspects of the present invention may be used with many types of environments. The computing environments provided herein are only examples.

In addition to the above, one or more aspects may be provided, offered, deployed, managed, serviced, etc. by a service provider who offers management of customer environments. For instance, the service provider can create, maintain, support, etc. computer code and/or a computer infrastructure that performs one or more aspects for one or more customers. In return, the service provider may receive payment from the customer under a subscription and/or fee agreement, as examples. Additionally, or alternatively, the service provider may receive payment from the sale of advertising content to one or more third parties.

In one aspect, an application may be deployed for performing one or more embodiments. As one example, the deploying of an application comprises providing computer infrastructure operable to perform one or more embodiments.

As a further aspect, a computing infrastructure may be deployed comprising integrating computer readable code into a computing system, in which the code in combination with the computing system is capable of performing one or more embodiments.

As yet a further aspect, a process for integrating computing infrastructure comprising integrating computer readable code into a computer system may be provided. The computer system comprises a computer readable medium, in which the computer medium comprises one or more embodiments. The code in combination with the computer system is capable of performing one or more embodiments.

Although various embodiments are described above, these are only examples. For example, other types of neural networks may be considered. Further, other scenarios may be contemplated. Many variations are possible.

Various aspects and embodiments are described herein. Further, many variations are possible without departing from a spirit of aspects of the present invention. It should be noted that, unless otherwise inconsistent, each aspect or feature described and/or claimed herein, and variants thereof, may be combinable with any other aspect or feature.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include” (and any form of include, such as “includes” and “including”), and “contain” (and any form contain, such as “contains” and “containing”) are open-ended linking verbs. As a result, a method or device that “comprises”, “has”, “includes” or “contains” one or more steps or elements possesses those one or more steps or elements, but is not limited to possessing only those one or more steps or elements. Likewise, a step of a method or an element of a device that “comprises”, “has”, “includes” or “contains” one or more features possesses those one or more features, but is not limited to possessing only those one or more features. Furthermore, a device or structure that is configured in a certain way is configured in at least that way, but may also be configured in ways that are not listed.

The corresponding structures, materials, acts, and equivalents of all means or step plus function elements in the claims below, if any, are intended to include any structure, material, or act for performing the function in combination with other claimed elements as specifically claimed. The description of one or more embodiments has been presented for purposes of illustration and description but is not intended to be exhaustive or limited to in the form disclosed. Many modifications and variations will be apparent to those of ordinary skill in the art. The embodiment was chosen and described in order to best explain various aspects and the practical application, and to enable others of ordinary skill in the art to understand various embodiments with various modifications as are suited to the particular use contemplated.

What is claimed is:

1. A computer-implemented method of facilitating processing within a computing environment, the computer-implemented method comprising:
obtaining a parameterization for a parallelized file system operation of a file system of the computing environment;
executing, and determining performance of, the parallelized file system operation with the parameterization;
using machine learning to adjust one or more parameters of the parameterization based on performance of the parallelized file system operation to obtain a tuned parameterization; and
executing the parallelized file system operation with the tuned parameterization, wherein the adjusting one or more parameters of the parameterization enhances performance of the parallelized file system operation within the computing environment.

2. The computer-implemented method of claim 1, wherein using machine learning to adjust one or more parameters of the parameterization comprises changing the one or more parameters heuristically based on a structure of the file system.

3. The computer-implemented method of claim 1, wherein the parameterization comprises an initial parameterization based on one or more expected average parameter values.

4. The computer-implemented method of claim 1, wherein determining performance of the parallelized file system operation with the parameterization comprises collecting data associated with the executing of the parallelized file system operation with the parameterization, and storing the collected data.

5. The computer-implemented method of claim 4, wherein using machine learning to adjust one or more parameters of the parameterization comprises:
determining a parameter delta for a parameter of the one or more parameters of the parameterization, and based on the parameter delta exceeding a parameter delta threshold, adjusting the parameter of the one or more parameters of the parameterization to, at least in part, obtain the tuned parameterization.

6. The computer-implemented method of claim 5, wherein using machine learning to adjust one or more parameters of the parameterization comprises using a machine learning model for mapping the collected data to the one or more parameters of the parameterization, the one or more parameters effecting a desired operational characteristic for executing the parallelized file system operation.

7. The computer-implemented method of claim 1, wherein the file system is a clustered file system and the executing the parallelized file system operation with the parameterization comprises:
obtaining multiple partitions of directories of the file system;
distributing partitions of the multiple partitions of directories of the file system among available processing threads of the computing environment; and
storing undistributed partitions in a common storage.

8. The computer-implemented method of claim 7, wherein the executing further comprises determining whether an average execution time of the parallelized file system operation exceeds an average execution time threshold, and based on the average execution time of the parallelized file system operation exceeding the average execution time threshold, spawning one or more new processing threads to facilitate execution of the parallelized file system operations with the parameterization on any remaining undistributed partitions in the common storage.

9. The computer-implemented method of claim 7, wherein the parameterization comprises multiple parameters, the multiple parameters comprising a maximum number of processing threads for use in executing the parallelized file system operation, a horizontal limit of directories for the multiple partitions of directories of the file system, and a vertical limit of sub-directories for the multiple partitions of directories of the file system.

10. A computer system for facilitating processing within a computing environment, the computer system comprising:
a memory; and
at least one processor in communication with the memory, wherein the computer system is configured to perform a method, said method comprising:
obtaining a parameterization for a parallelized file system operation of a file system of the computing environment;
executing, and determining performance of, the parallelized file system operation with the parameterization;
using machine learning to adjust one or more parameters of the parameterization based on performance of the parallelized file system operation to obtain a tuned parameterization; and
executing the parallelized file system operation with the tuned parameterization, wherein the adjusting one or more parameters of the parameterization enhances performance of the parallelized file system operation within the computing environment.

11. The computer system of claim 10, wherein using machine learning to adjust one or more parameters of the parameterization comprises changing the one or more parameters heuristically based on a structure of the file system.

12. The computer system of claim 10, wherein determining performance of the parallelized file system operation with the parameterization comprises collecting data associated with the executing of the parallelized file system operation with the parameterization, and storing the collected data, and wherein using machine learning to adjust the one or more parameters of the parameterization includes determining a parameter delta for a parameter of the one or more parameters of the parameterization, and based on the parameter delta exceeding a parameter delta threshold, adjusting the parameter of the one or more parameters of the parameterization to, at least in part, obtain the tuned parameterization.

13. The computer system of claim 12, wherein using machine learning to adjust one or more parameters of the parameterization comprises using a machine learning model for mapping the collected data to the one or more parameters of the parameterization, the one or more parameters effecting a desired operational characteristic for executing the parallelized file system operation.

14. The computer system of claim 10, wherein the file system is a clustered file system and the executing the parallelized file system operation with the parameterization comprises:
obtaining multiple partitions of directories of the file system;
distributing partitions of the multiple partitions of directories of the file system among available processing threads of the computing environment; and
storing undistributed partitions in a common storage.

15. The computer system of claim 14, wherein the executing further comprises determining whether an average execution time of the parallelized file system operation exceeds an average execution time threshold, and based on the average execution time of the parallelized file system operation exceeding the average execution time threshold, spawning one or more new processing threads to facilitate execution of the parallelized file system operations with the parameterization on any remaining undistributed partitions in the common storage.

16. The computer system of claim 14, wherein the parameterization comprises multiple parameters, the multiple parameters comprising a maximum number of processing threads for use in executing the parallelized file system operation, a horizontal limit of directories for the multiple partitions of directories of the file system, and a vertical limit of sub-directories for the multiple partitions of directories of the file system.

17. A computer program product for facilitating processing within a computing environment, the computer program product comprising:
one or more computer readable storage media and program instructions collectively stored on the one or more computer readable storage media to perform a method comprising:
obtaining a parameterization for a parallelized file system operation of a file system of the computing environment;
executing, and determining performance of, the parallelized file system operation with the parameterization;
using machine learning to adjust one or more parameters of the parameterization based on performance of the parallelized file system operation to obtain a tuned parameterization; and
executing the parallelized file system operation with the tuned parameterization, wherein the adjusting one or more parameters of the parameterization enhances performance of the parallelized file system operation within the computing environment.

18. The computer program product of claim 17, wherein using machine learning to adjust one or more parameters of the parameterization comprises changing the one or more parameters heuristically based on a structure of the file system.

19. The computer program product of claim 17, wherein determining performance of the parallelized file system operation with the parameterization comprises collecting data associated with the executing of the parallelized file system operation with the parameterization, and storing the collected data, and wherein using machine learning to adjust one or more parameters of the parameterization includes determining a parameter delta for a parameter of the one or more parameters of the parameterization, and based on the parameter delta exceeding a parameter delta threshold, adjusting the parameter of the one or more parameters of the parameterization to, at least in part, obtain the tuned parameterization.

20. The computer program product of claim 19, wherein using machine learning to adjust one or more parameters of the parameterization comprises using a machine learning model for mapping the collected data to the one or more parameters of the parameterization, the one or more parameters effecting a desired operational characteristic for executing the parallelized file system operation.
